(19) United States
(12) Patent Application Publication
(10) Pub. No.: US 2010/0332206 A1
(43) Pub. Date: Dec. 30, 2010

(54) METHOD FOR SIMULATING LEAKAGE DISTRIBUTION OF INTEGRATED CIRCUIT DESIGN

(76) Inventor: Iyun Leu, Hsinchu City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/491,382

(22) Filed: Jun. 25, 2009

(51) Int. Cl. G06F 17/50

(52) U.S. Cl. 703/14; 716/103; 716/139; 716/50

(57) ABSTRACT

A method is provided for simulating leakage distribution of integrated circuit design. The method analyzes a layout of the integrated circuit design to understand the groups of dimensions of the transistors and capacitors of the layout, and then simulates a leakage distribution of the layout resulted from possible fabrication process variations. Therefore, designer can know the leakage distribution of the integrated circuit design before the integrated circuit design is actually fabricated, and modify the layout if a leakage failure happens to the layout.

### FIELD OF THE INVENTION

The present invention relates to a method for simulating leakage distribution of integrated circuit design, in particular, to a method for simulating leakage distribution of integrated circuit design within integrated circuit design process.

### DESCRIPTION OF RELATED ART

Generally, an integrated circuit (IC) device is designed by an IC design company, commonly called “design house”. The IC design house provides a layout of the IC device to a semiconductor fabrication plant, commonly called “fab”, and then the fab fabricates the IC device according to the layout.

During the fabrication process of the IC device, the process variations in Active Critical Dimension (CD), Poly Critical Dimension, thickness of gate dielectric layer, composition, implant condition, and the like, are affecting the driving current (I_{dsat}) distribution of the IC device. The leakage current of the IC device is also affected by those process variations, so the leakage current would have a distribution range. If some of the leakage distribution of product wafer are out of spec requirement that specified by the design house, it would be categorized as leakage failure.

However, these leakage failures will not be known until that the design house receives the wafer containing the IC device from the fab and tests the wafer, which usually several months has been passed from the time that the layout of the IC device is completed. In other words, the design house can not immediately know that whether its layout has low leakage failures or not, not to mention modification of the layout.

Accordingly, the present invention is provided, because of the above specified disadvantages of the prior art and based on hands on experience plus academic research and developments, to effectively improve the advantages described above.

### SUMMARY OF THE INVENTION

A main object of the present invention is to provide a method for simulating leakage distribution of integrated circuit design, which is capable of simulating the leakage distribution of the integrated circuit design before the integrated circuit design is actually fabricated in the semiconductor fabrication plant.

To achieve the above-mentioned objectives, an embodiment of the present invention provides a method for simulating leakage distribution of integrated circuit design, comprising steps of: (a) obtaining a netlist of a layout of an integrated circuit design having a plurality of transistors and a plurality of capacitors; (b) analyzing the netlist to obtain a plurality of groups of dimensions of the transistors and the capacitors, and counts of the transistors and capacitors corresponding to the groups of dimensions; (c) obtaining a plurality of process windows of a process for fabricating the transistors and the capacitors; (d) varying the groups of dimensions of the transistors and the capacitors based on the process windows; (e) simulating a leakage value for each of the groups of dimensions of the transistors and the capacitors after varied, wherein the leakage value is simulated by a simulation program with integrated circuit emphasis; (f) multiplying the leakage value of each of the groups of dimensions with the count corresponding to the group of dimensions; (g) calculating the leakage values after multiplied, so as to obtain a full chip leakage value; (h) repeating step (d) to (g), so as to obtain other full chip leakage values; and (i) generating a leakage distribution from the full chip leakages values.

The efficacy of the present invention is as follows. Before the integrated circuit design is actually fabricated, the leakage distributions of the integrated circuit design due to the possible process variation can be known in advance. Therefore, if the leakage distributions are out of spec requirements, the layout can be modified immediately to reduce or improve the potential leakage failure. That is, the leakage failure can be previewed in the design stage within the design house, prior to the fabrication stage within the semiconductor fabrication plant.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 shows a first flowchart diagram according to a preferred embodiment of the present invention;

FIG. 2 shows a schematic diagram of an table of groups of dimensions according to a preferred embodiment of the present invention;

FIG. 3 shows a schematic diagram of an table of variation of groups of dimensions according to a preferred embodiment of the present invention;

FIG. 4 shows a second flowchart diagram according to a preferred embodiment of the present invention; and

FIG. 5 shows a third flowchart diagram according to a preferred embodiment of the present invention.

### DETAILED DESCRIPTION OF THE PREFERRED EMBODIMENTS

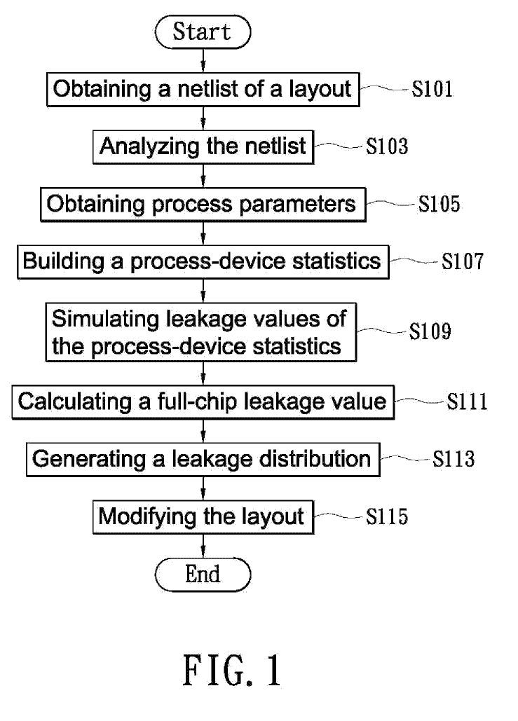

Please refer now to FIG. 1, a preferred embodiment according to the present invention discloses a method for simulating leakage distribution of integrated circuit design. The method can be implemented within an integrated circuit design process, which helps engineers design a layout of integrated circuit device with reduced leakage failure. The method can be performed by software, or in combination with software and hardware; and by a single computer, or with multiple computers that interact with one another. Via this method of the embodiment, potential leakage failure of an integrated circuit design can be estimated in the design stage.

Please still refer to FIG. 1; the detailed workflow of the method for simulating leakage distribution of integrated circuit design is set forth as below.

At step S101, the engineer of a design house selects a layout of an integrated circuit design which is aimed to be simulated its leakage distribution through following steps. The layout shows dimensions, shapes, orientations, types, and positions, etc. of a plurality of transistors, capacitors, and interconnections, etc., of the integrated circuit design. The layout is usually mapped to a netlist file, and the netlist is stored in a database. The netlist records the layout by text-format, so it can be analyzed easily by the computer. The netlist corresponding to the layout will be extracted from the database for further utilizations.

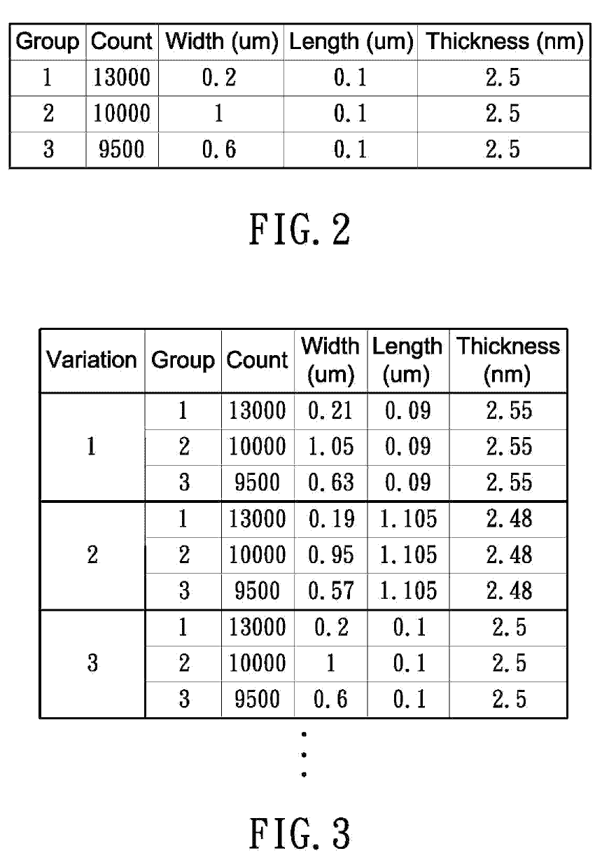

At step S103, the netlist extracted is analyzed, so as to respectively categorize the transistors and the capacitors of the layout into a plurality of groups by their dimensions. The transistors having the same dimensions are assigned into the same group; the capacitors having the same dimensions are assigned into the same group. The dimensions of the transistor and capacitors used for categorizing comprise: channel width, channel length, and thickness of gate dielectric layer, etc., which are critical to the performance of the transistors and capacitors. Please refer to FIG. 2, a table shows some of the groups of the transistors, information of each group comprises: count, and dimensions, etc., of the transistors. In other words, after analyzing netlist, groups of dimensions (width, length, and thickness) of the transistors and capacitors will be obtained, and the count of the transistors and capacitors corresponding to the group of dimensions will be also obtained. That is, distribution of dimensions versus count of the transistors and capacitors can be known.

At step S105, process parameters of a process for fabricating the layout will be extracted from the database of the design house. The process parameters are originally stored in a semiconductor fabrication plant, i.e. fab, and provided for the design house. The process parameters comprise: active critical dimension (CD), poly critical dimension, and thickness of gate dielectric layer, etc., which dominate the dimensions of the transistor and the capacitor. Because the process parameters are varied within a range during fabrication process, each of the process parameters has a process window (tolerance), i.e. a target and deviation from the target.

At step S107, after obtaining the process windows of the process parameters, a process-device statistics is built from the process windows, and the groups of dimensions of the transistors and the capacitors. The process-device statistics consists of several variations of the groups of dimension of the transistors and the capacitors. That is, the groups of dimension are varied randomly based on the process windows for several times. Please referring to FIG. 3, a table shows some variation of the process-device statistics. Every variation for the group of dimension represents a possible fabricated water according to the layout. Therefore, the groups of dimension are varied for more times, more possible fabricated wafers are considered; the leakage distribution simulation is thus more accurate.

At step S109, a leakage value of each one of the varied groups of dimensions of the process-device statistic is simulated, other electrical characteristics, such as saturation driving current, threshold voltage, and resistance, of each one of the groups of dimension are also simulated. The leakage value and other electrical characteristics can be simulated by some commercial software, such as simulation program with integrated circuit emphasis (SPICE), or other theoretical equations.

At step S111, every leakage value of the group of dimensions is multiplied with the count corresponding to the group of dimensions; the other electrical characteristics of the group of dimensions are also multiplied with the count. Then the after-multiplied leakage values of the groups of the dimensions within the same variation are calculated, so as to obtain a full-chip leakage value (total leakage value) for the variation. The other after-multiplied electrical characteristics within the same variation are calculated too.

The step S111 is performed repeatedly for all the variations of the process-device statistics, so the full-chip leakage values of the variations are obtained in end of step S111. Then at step S113, a leakage distribution is generated from the full-chip leakage values of the process-device-statistics.

At step S115, the leakage distribution will be checked to see whether it exceeds the spec requirement. If the leakage distribution exceeds the spec requirement, it may cause a leakage failure. The layout or the process for fabricating the layout should be modified to reduce or improve the leakage failure; mainly the dimensions of transistor and capacitors will be modified.

Moreover, at step S109, the process-device statistics can be calibrated by a device test data. The device test data is extracted from a fabricated integrated circuit design, so the device test data comprises actual electrical characteristics. Each variation's simulated electrical characteristics are compared with the actual electrical characteristics if the simulated electrical characteristics of one variation are too different from the actual electrical characteristics, the step S111 will be skipped for the variation.

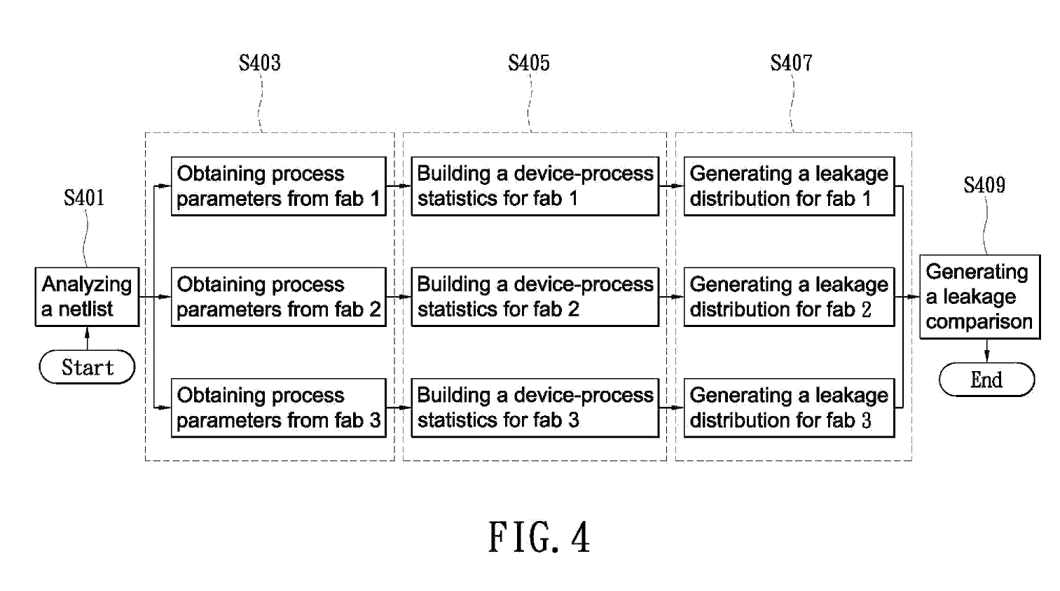

Usually, the layout of integrated circuit design can be fabricated by different fabs, and each fab has its own process parameters and process variations. So the leakage distribution of the layout will be varied at different fabs. The method of the embodiment can be implemented for different fabs, so as to generate a leakage comparison among the fabs. Then designers can know which fab is better for the leakage distribution from the leakage comparison. Please refer to FIG. 4, and association with FIG. 1; the detail workflow is set forth as follow.

At step S401, a layout of an integrated circuit design is selected, and a netlist corresponding to the layout is extracted from database, and analyzed to generate the transistor and the capacitors distribution. Step S401 is similar to steps S101 to S103. At step S403, process parameters of a process for fabricating the transistors and the capacitors are obtained from a plurality of fabs. In this embodiment, the number of the fabs is 3. Process parameters of each fab are different, and have their own process variation, i.e. process windows. The step S403 is similar to S105 applied to plural fabs.

At step S405, a process-device statistics for each one of the fabs is built from the process windows, which is similar to steps S107. Next, at step S407, a leakage distribution for each one of the process-device statistics is generated from steps S109 to S113. That is, the leakage distribution of each fab is generated.

At step S409, after leakage distributions of the different fabs are generated, a leakage comparison among the leakage distributions is generated. Engineers can understand which fab yields better leakage distribution for their layout of integrated circuit design from the leakage comparison; thus choose the proper fab.

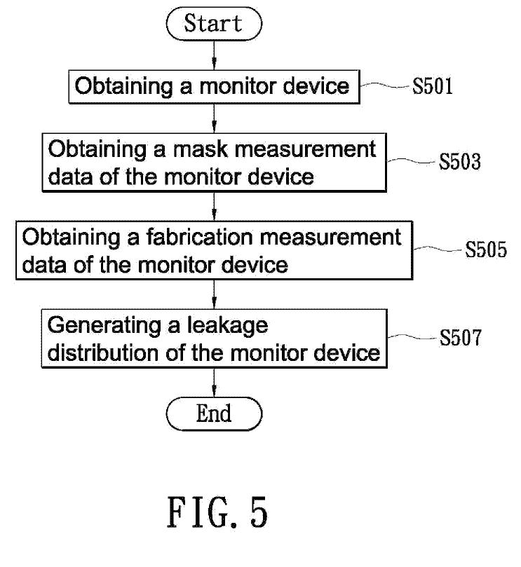

Please refer to FIG. 5, and association with FIG. 1; the method for simulating leakage distribution of integrated circuit design has further steps as set forth as follow.

At step S501, a monitor device is obtained from a GDS. The monitor device is a group of transistors in a design and represents the typical process sensitive pattern in mask and fab manufacturing process. The monitor device is obtained by a monitor device criterion, such as pattern density orientation pitch, or identical or close dimension of transistor etc. The extracted monitor device has a similar layout to the layout that engineer selects at step S101.

At step S503, a mask measurement data of the monitor device is obtained from the mask manufacturer, so as to know off-target dimension variations of the mask of the monitor device. The dimensions of the layout of the monitor device will be varied from those of the mask of the monitor device due to the fabrication tolerances. From the mask measurement data, the dimension variation of the mask from target can be known. Then at step S505, a fabrication measurement data of the monitor device is obtained from the fab, so as to know process variation of the monitor device. The fabrication measurement data comprises lithographic measurement data, and etch measurement data, etc.

At step S507, a leakage distribution due to the dimension variations and process variations is calculated, so as to know leakage distribution of the monitor device. If the leakage distribution exceeds the spec requirement, the engineer can further modify the layout selected, or modify the process parameter.

To sum up the present invention, the method for simulating leakage distribution of integrated circuit design has advantages as follows. The method can simulate a leakage distribution for a layout before the layout is actually fabricated by the fab. If the leakage distribution is not complied with the spec requirement, designer can modify the layout in order to improve or reduce the leakage distribution. The method can be implemented for different fabs, and generates a leakage comparison among the fabs. So designer can know which fab yields a better leakage distribution for the layout. The method can reduce cost and time of an integrated design process, etc.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for simulating leakage distribution of integrated circuit design, comprising steps of:
(a) obtaining a netlist of a layout of an integrated circuit design having a plurality of transistors and a plurality of capacitors;
(b) analyzing the netlist to obtain a plurality of groups of dimensions of the transistors and the capacitors, and counts of the transistors and capacitors corresponding to the groups of dimensions;
(c) obtaining a plurality of process windows of a process for fabricating the transistors and the capacitors;
(d) varying the groups of dimensions of the transistors and the capacitors based on the process windows;
(e) simulating a leakage value for each of the groups of dimensions of the transistors and the capacitors after varied, wherein the leakage value is simulated by a simulation program with integrated circuit emphasis;
(f) multiplying the leakage value of each of the groups of dimensions with the count corresponding to the group of dimensions;
(g) calculating the leakage values after multiplied, so as to obtain a full chip leakage value;
(h) repeating step (d) to (g), so as to obtain other full chip leakage values; and
(i) generating a leakage distribution from the full chip leakages values.

2. The method as claimed in claim 1, further comprising a step of:
checking the leakage distribution satisfying a spec requirement.

3. The method as claimed in claim 1, further comprising a step of:
modifying the layout to reduce the leakage distribution.

4. The method as claimed in claim 1, wherein the group of dimensions of the transistor comprises: channel width, channel length, and thickness of gate dielectric layer.

5. The method as claimed in claim 1, wherein in the step (c), electrical characteristics are also simulated for each of the groups of dimensions of the transistors and capacitors after varied; the electrical characteristics are simulated by the simulation program with integrated circuit emphasis.

6. The method as claimed in claim 5, wherein the electrical characteristics comprises: saturation driving current, threshold voltage, and resistance.

7. The method as claimed in claim 5, further comprising steps of:
obtaining a device test data having actual electrical characteristics; and
using the device test data to calibrate a process-device statistics.

8. The method as claimed in claim 1 wherein the step (a) to step (i) are repeated for a plurality of semiconductor fabrication plants, so as to generate a leakage distribution of each one of the semiconductor fabrication plants.

9. The method as claimed in claim 8, further comprising a step of:
generating a leakage comparison among the leakage distributions of the semiconductor fabrication plants.

10. The method as claimed in claim 1, further comprising steps of:
obtaining a monitor device from the layout by a monitor device criterion;
obtaining a mask measurement data of the monitor device, so as to obtain a dimension variation of a mask of the monitor device;
obtaining a fabrication measurement data of the monitor device, so as to obtain a process variation of the monitor device; and
generating a leakage distribution of the monitor device.

11. The method as claimed in claim 10, wherein the monitor device criterion comprises: pattern density, orientation, pitch, and dimension of transistor.
